(19) United States
(12) Patent Application Publication
(10) Pub. No.: US 2023/0111969 A1
(43) Pub. Date: Apr. 13, 2023

(54) LASER CUTTING METHOD AND LASER CUTTING APPARATUS

(71) Applicant: TRUMPF Laser- und Systemtechnik GmbH, Ditzingen (DE)

(72) Inventors: Hamza Dounassre, Stuttgart (DE); Tim Hesse, Ditzingen (DE); Olga Kramlich, Pforzheim (DE); Johannes Seebach, Stuttgart (DE); Nicolai Speker, Pleidelsheim (DE)

(21) Appl. No.: 18/053,384

(22) Filed: Nov. 8, 2022

Related U.S. Application Data
(63) Continuation of application No. PCT/EP2021/062440, filed on May 11, 2021.

(30) Foreign Application Priority Data
May 12, 2020 (DE) 10 2020 205 948.9

(51) Int. Cl. B23K 26/38; B23K 26/06; B23K 26/14

(52) U.S. Cl. CPC B23K 26/38; B23K 26/0608; B23K 26/14

(57) ABSTRACT

A method for laser cutting a workpiece having a thickness of less than 6 mm includes the steps of directing a first laser beam, a second laser beam, and a gas jet at an entrance surface of the workpiece such that the first and second laser beams at least partially overlap one another on the workpiece. The first laser beam has a smaller focus diameter than the second laser beam, a beam parameter product of the first laser beam is at most 5 mm*mrad, and a power proportion of the second laser beam of a total laser power is less than 20%. A cutting kerf with a broken cutting edge is formed on the entrance surface of the workpiece.

### CROSS REFERENCE TO RELATED APPLICATIONS

This application is a continuation of International Application No. PCT/EP2021/062440 (WO 2021/228829 A1), filed on May 11, 2021, and claims benefit to German Patent Application No. DE 10 2020 205 948.9, filed on May 12, 2020. The aforementioned applications are hereby incorporated by reference herein.

### FIELD

The invention relates to a method for laser cutting a workpiece having a thickness of less than 6 mm. The invention furthermore relates to a laser cutting apparatus for laser cutting an, in particular three-dimensionally shaped, metal-sheet-type workpiece along a three-dimensional cutting line.

### BACKGROUND

As focus diameters become increasingly smaller, the feed rate (the cutting speed) during laser cutting can be increased with the same laser power. However, this is limited by the fact that, if the focus is too small, the cutting quality becomes unacceptable. In particular, burr formation takes place. This burr formation is caused by the fact that less and less cutting gas penetrates into the cutting kerf as the cutting kerf gets smaller and smaller, and so it is not ensured that the molten metal is ejected.

For this reason, endeavors have been made in recent years primarily to influence the beam properties when cutting increasingly thicker workpieces with solid-state lasers and in particular to enlarge the focus diameter to create wider cutting kerfs and improve the ejection of the molten metal.

For example, WO2011124671A1, WO2013000942A1, WO2014060091A1, US20180188544A1 or WO2018104575A1 has thus described influencing the beam quality and thus the focusability of a solid-state laser beam by coupling the beam into different cores of a multicore fiber in order to be able to cut different workpieces, in particular workpieces having different thicknesses.

In addition, DE60206184T2 or JP2000005892A has proposed to split the laser beam during laser cutting with the aid of transmissive or reflective optical elements into a plurality of partial beams that are focused at a plurality of focus points in the workpiece with an offset in the beam propagation direction. The ability to cut workpieces that are as thick as possible is likewise an objective.

### SUMMARY

In an embodiment, the present disclosure provides a method for laser cutting a workpiece having a thickness of less than 6 mm that includes the steps of directing a first laser beam, a second laser beam, and a gas jet at an entrance surface of the workpiece such that the first and second laser beams at least partially overlap one another on the workpiece. The first laser beam has a smaller focus diameter than the second laser beam, a beam parameter product of the first laser beam is at most 5 mm*mrad, and a power proportion of the second laser beam of a total laser power is less than 20%. A cutting kerf with a broken cutting edge is formed on the entrance surface of the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic side view of a laser cutting apparatus according to the invention during the performance of a laser cutting method according to the invention with overlay of a first and a second laser beam, which emerge from a common multicore fiber and overlap one another in a cutting zone on the workpiece;

FIG. 1b shows a schematic cross-sectional view through the multicore fiber of the laser cutting apparatus of FIG. 1a, wherein it is possible to see that a first fiber core for the first laser beam is arranged concentrically inside a second fiber core for the second laser beam;

FIG. 2 shows a schematic flowchart of a laser beam method according to the invention;

FIG. 3a shows a schematic illustration of the beam path of the first and the second laser beam in a laser cutting method according to the invention;

FIG. 3b shows a schematic illustration of the beam path of the first and the second laser beam when they emerge from a multicore fiber having two concentric fiber cores in a laser cutting method according to the invention;

FIG. 4a shows a schematic perspective view of a workpiece during the introduction of a cutting kerf as part of a laser cutting method according to the invention, wherein the two laser beams and a gas jet emerging from a nozzle are directed at an entrance surface of the workpiece;

FIG. 4b shows a schematic cross-sectional view through the workpiece of FIG. 4a in the region of the cutting kerf which has rounded cutting edges at the entrance surface;

FIG. 4c shows a schematic cross-sectional view of an alternative embodiment of cutting edges at a cutting kerf with bevels between cutting flanks and the entrance surface in one variant of the laser cutting method according to the invention;

FIG. 5 show a schematic cross section through a workpiece with a cutting kerf produced by a laser cutting method according to the prior art;

FIG. 6a and FIG. 6b show schematic views of further laser cutting apparatuses according to the invention during the performance of a laser cutting method according to the invention with overlay of a first and a second laser beam, which are produced in separate laser light sources and are focused at different depths in a workpiece;

FIG. 7a shows a diagram of cutting speeds that are ascertained experimentally during a laser cutting method according to the invention and at which a good cutting edge quality is still attained, as a function of the focus location of the first laser beam relative to the entrance surface at a power proportion of the second laser beam of the total laser power of 10%; and

FIG. 7b shows a diagram as in FIG. 7a, but at a power proportion of the second laser beam of the total laser power of 5%.

### DETAILED DESCRIPTION

It is an aspect of the present invention to specify a laser cutting method for thin workpieces having a thickness of less than 6 mm, in which high cutting speeds and good cutting quality are combined. It is furthermore an aspect of the present invention to specify a laser cutting apparatus for efficiently laser cutting workpieces having a thickness of less than 6 mm with a good cutting quality, which is suitable in particular for cutting three-dimensionally shaped metal sheets.

According to an aspect of the invention, a method for laser cutting a workpiece having a thickness of less than 6 mm is provided. Workpieces having such a thickness are frequently cut on 3D laser cutting apparatuses and used, for example, in car-body construction. The workpiece is preferably cut along a three-dimensionally extending cutting line. Laser cutting is preferably effected by laser fusion cutting. In laser fusion cutting, the material of the workpiece is melted to form a cutting kerf and is evacuated in liquid form from the cutting kerf. The workpiece can be a metal sheet, in particular a three-dimensionally shaped metal sheet. The workpiece preferably consists of a metallic and/or electrically conductive material. The method according to the invention is preferably carried out with a laser cutting apparatus according to the invention, which is described below.

In the laser cutting method according to an aspect of the invention, a first laser beam, a second laser beam, and a gas jet are directed at an entrance surface of the workpiece. The two laser beams and the gas jet cause material to melt and be removed from the workpiece, forming a cutting kerf. The entrance surface is the surface of the workpiece on which the beams and the jet are incident. Once the cutting kerf has formed, portions of the beams and the jet typically emerge from the workpiece at the opposite exit surface. The first and the second laser beam are typically formed in each case by a single laser beam. However, alternatively, the first and/or in particular the second laser beam can consist of a plurality of partial beams in each case. The two laser beams can be produced using a common laser light source and be separated from one another using a beam splitter. Alternatively, each of the two laser beams can be produced using a separate laser light source. The cutting gas in the gas jet which has been directed at the entrance surface and injected into the cutting kerf can be nitrogen or compressed air, for example. In special cases, the cutting gas can also be argon.

The laser beams at least partially overlap one another on the workpiece. In other words, the two laser beams simultaneously cover a common region on the surface or in the volume of the workpiece or in the cutting kerf in each case. The first laser beam preferably extends in the region of the workpiece entirely inside the second laser beam. In particular, the two laser beams can be overlaid to form one overall laser beam.

The first laser beam has a smaller focus diameter than the second laser beam. The beam parameter product of the first laser beam is, according to an aspect of the invention, at most 5 mm*mrad. With preference, the beam parameter product of the first laser beam is at most 3 mm*mrad and with particular preference at most 2 mm*mrad. The high beam quality of the first laser beam makes particularly high cutting speeds possible. In other words, if a beam parameter product of the first laser beam is small, i.e. with a high beam quality, the productivity of the method according to an aspect of the invention can be increased. The beam parameter product is defined as the product of the half angle of the laser beam in the far field and the radius of the laser beam at its thinnest point, i.e. half the focus diameter.

According to an aspect of the invention, provision is made for a power proportion of the second laser beam of the total laser power to be less than 20%. The total laser power is the sum of the laser powers of the first and the second laser beam. In other words, the power proportion of the first laser beam of the total laser power is at least 80%. The power proportion of the second laser beam of the total laser power is greater than zero. Typically, the power proportion of the second laser beam of the total laser power is at least 2%, preferably at least 3%. It has been found according to an aspect of the invention that in the case of thin workpieces having a thickness of less than 6 mm, high beam quality and a small focus diameter of the actual cutting beam (the first laser beam) enable the cutting speed (and consequently the productivity) to be increased while at the same time attaining a good quality of the cutting flanks at the cutting kerf when a specific part of the total laser power is focused onto the workpiece with a larger diameter (i.e. over the second laser beam). The total laser power can be at least 1 kW, preferably at least 2 kW.

Owing to the lower-power second laser beam surrounding the first laser beam (the actual cutting beam), the coupling efficiency of the cutting gas from the gas jet into the cutting kerf is improved. The method parameters are selected according to an aspect of the invention such that the cutting kerf is geometrically shaped such that conditions which are favorable in terms of flow for the cutting gas arise. According to an aspect of the invention, the cutting kerf with a broken cutting edge is formed for this purpose on the entrance surface of the workpiece. A broken cutting edge is understood to mean in particular a cutting edge that has an ablated area, i.e. a rounded or beveled cutting edge. The common intensity profile of the overlapping laser beams is designed such that the cutting kerf at the entrance surface is formed to be funnel-shaped. The funnel forms a lead-in radius or a lead-in bevel at the cutting flanks of the cutting kerf. The funnel makes it possible for the cutting gas to be able to flow into the cutting kerf with minor resistance. The pressure loss due to impacts and turbulence is significantly lower at the broken cutting edge than at a rectangular, right-angled (sharp) edge.

The cutting edge is preferably rounded. A radius of the cutting edge can be at least 20 μm, preferably at least 25 μm, and/or at most 100 μm, preferably at most 60 μm, with particular preference at most 35 μm. With very particular preference, the radius is 30 μm. These values for the radius bring about particularly advantageous conditions for the inflow of the cutting gas.

The method parameters are selected such that both the highest possible cutting speed (productivity) and also a good cutting quality are achieved. On the one hand, the power of the actual cutting beam (the first laser beam) having a smaller beam diameter and a high beam quality should be large enough to achieve a high cutting speed. On the other hand, the power of the partial beam having a greater beam diameter (the second laser beam) must be sufficiently high for the ablated area to form at the cutting edge of the cutting kerf. The power proportion of the outer, second laser beam is for this purpose advantageously selected depending on the thickness of the workpiece.

The thickness of the workpiece can be less than 5 mm and preferably more than 3 mm. In particular, the thickness can be 4 mm. The power proportion of the second laser beam of the total laser power is then preferably less than 15%.

The thickness of the workpiece can be less than 3 mm and preferably more than 1 mm. In particular, the thickness can be 2 mm. The power proportion of the second laser beam of the total laser power is then preferably less than 7%, in particular 5%.

The previously mentioned values help to bring about a good compromise between expanding the cutting kerf lead-in (due to the ablated area of the cutting edge at the entrance surface) and the highest possible productivity, i.e. cutting speed.

The focus point of the first laser beam can lie upstream of the focus point of the second laser beam in the propagation direction of the laser beams. The focus point of the first laser beam can lie within the workpiece, preferably in the half of the workpiece that is closer to the entrance surface, or outside the workpiece. The focus point of the second laser beam then lies deeper inside the workpiece, or closer to the entrance surface. The focus point of the (high-power) first laser beam preferably lies in the region of the workpiece surface. In particular, a distance of the focus point of the first laser beam from the entrance surface can be less than 30%, preferably less than 15%, of the thickness of the workpiece. A distance between the focus points of the two laser beams is preferably at most 2 mm, in particular at most 1 mm, and typically between 0.5 and 0.7 mm.

A distance of the focus point of the second laser beam from the entrance surface of the workpiece can be at most twice the Rayleigh length of the second laser beam. The Rayleigh length is defined as the quotient of the product of the refractive index of the propagation medium, the circle number pi and the square of the radius of the laser beam in the focus point as the dividend and the vacuum wavelength of the laser light as the divisor.

The focus diameter of the second laser beam can be at least twice, preferably at least three times, and/or at most five times, preferably at most four times, the focus diameter of the first laser beam. In particular, the focus diameter of the first laser beam can be at least 50 μm, preferably at least 80 μm, and/or at most 300 μm, preferably at most 150 μm. These value ranges have proven useful for different workpiece thicknesses of up to 6 mm.

The propagation axes of the two laser beams can be inclined with respect to one another or preferably be parallel to one another. Advantageously, the propagation axes coincide.

The divergences of the first and second laser beam in the far field can be the same or differ by at most ΔΘ=100 mrad. This enables a simple design of the optical system for guiding and focusing the laser beams, which contributes to the process reliability of the method.

The two laser beams can be overlaid eccentrically with respect to one another. However, the two laser beams are advantageously overlaid concentrically with respect to one another. In this way, it is possible to cut in all directions, without the orientation of the two laser beams needing to be adapted to the cutting direction, for example by rotating an optical unit in a cutting head.

Provision may be made for the two laser beams to emerge from a multicore fiber having a first fiber core for the first laser beam and a second fiber core for the second laser beam. The multicore fiber can have fibers running parallel to one another. Preferably, the second fiber core surrounds the first fiber core. In other words, the first fiber core is arranged radially inside the second fiber core. The second fiber core is therefore embodied in the form of a ring fiber. In particular, the first and the second fiber cores can be concentric with respect to each other.

The first fiber core, from which the first laser beam emerges, can have a diameter of at most 100 μm, preferably at most 50 μm. The second fiber core, from which the second laser beam emerges, can have a diameter of at most 300 μm, preferably at most 200 μm.

The gas jet of the cutting gas can emerge from a conical nozzle having a round or oval opening diameter, a secondary flow nozzle or a de Laval nozzle. A gas pressure, in particular a dynamic gas pressure, of the gas flow after it emerges from the nozzle can be at least 16 bar, preferably at least 18 bar, and/or at most 24 bar, preferably at most 22 bar. With such a gas pressure, the material of the workpiece can be reliably evacuated from the cutting kerf, in particular without burrs forming on the exit surface.

A laser cutting apparatus for laser cutting an, in particular three-dimensionally shaped, metal-sheet-type workpiece along an, in particular three-dimensional, cutting line furthermore falls within the scope of the present invention. The laser cutting apparatus is preferably a laser fusion cutting apparatus for laser fusion cutting. The laser cutting apparatus is advantageously configured for carrying out the laser cutting method according to an aspect of the invention, which was described above. In particular, substantive features which are described above can be provided in the laser cutting apparatus according to an aspect of the invention. The laser cutting apparatus can be configured to produce the first laser beam, the second laser beam, and/or the gas jet with above-described parameters and to direct them at the workpiece in the manner described above.

The laser cutting apparatus has a laser light source device for overlaying a first laser beam and a second laser beam in a cutting zone. The first laser beam has a smaller beam diameter and a smaller focus diameter than the second laser beam. The beam parameter product of the first laser beam is at most 5 mm*mrad, preferably at most 3 mm*mrad. A power proportion of the second laser beam of the total laser power is less than 20%. The laser light source device can have an optical unit for focusing the two laser beams in the cutting zone.

The laser cutting apparatus furthermore has a nozzle for directing a gas jet at the cutting zone. The gas jet provides cutting gas, for example nitrogen, compressed air or argon, for evacuating material of the workpiece from the cutting kerf that forms during laser cutting. The two laser beams typically exit through the nozzle.

The laser cutting apparatus furthermore has a movement device for moving the cutting zone relative to the workpiece along the three-dimensional cutting line. The laser cutting apparatus can have a workpiece holder that is arranged fixedly at the laser cutting apparatus, in particular at a machine bed of the laser cutting apparatus. An optical unit of the laser light source device or the entire laser light source device and the nozzle can be translationally and/or rotationally displaceable or rotatable, in particular relative to the machine bed. Alternatively, the workpiece holder can be movably arranged at a machine bed of the laser cutting apparatus. The optical unit or the laser light source device and the nozzle can then be arranged fixedly at the laser cutting apparatus. It is also conceivable to create a few degrees of freedom of the relative movement by way of a movability of the workpiece holder, for example in one or more translational directions, and other degrees of freedom by way of a movability of the optical unit or of the laser light source device and the nozzle, in particular by way of a rotability about one or more axes.

Further features and advantages of the invention are evident from the description and the drawing. According to the invention, the features mentioned above and those still to be further presented can be used in each case individually or together in any desired expedient combinations. The embodiments shown and described should not be understood as an exhaustive enumeration, but rather are of illustrative character for outlining the invention.

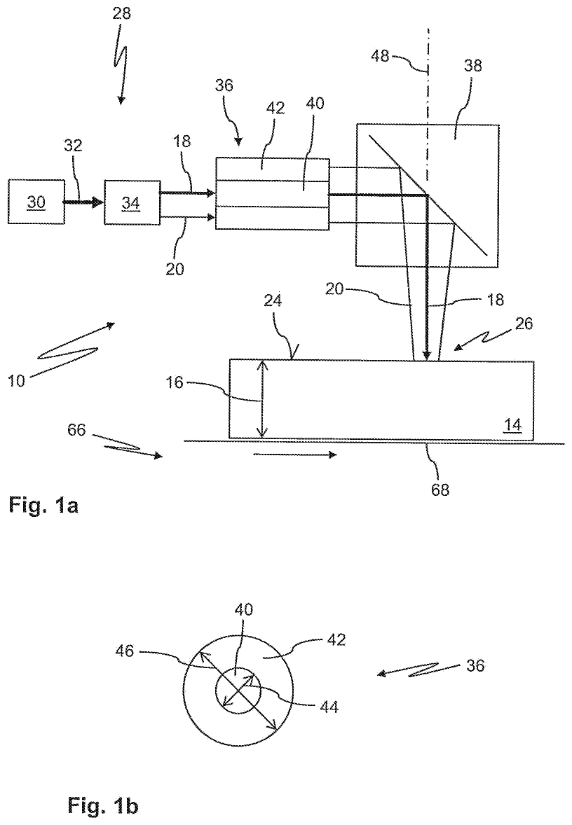

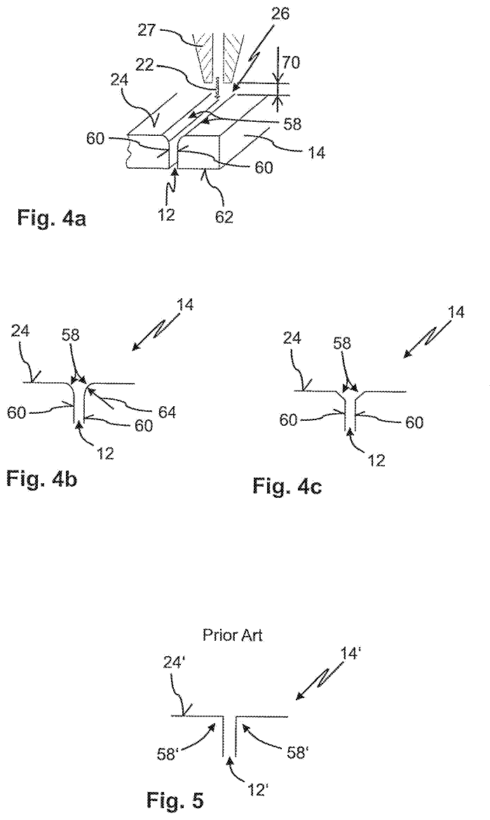

FIG. 1a schematically shows a laser cutting apparatus 10 during the performance of a laser cutting method, here a laser fusion cutting method. In the laser cutting method, a cutting kerf 12 (see FIG. 4a, to which reference will be additionally made below) is introduced into a workpiece 14. The workpiece 14 is embodied in the form of a metal sheet and has a thickness 16 of less than 6 mm. The thickness 16 is here 2 mm, by way of example. The workpiece 14 can be three-dimensionally curved at least in part in a manner that is not illustrated in more detail.

In order to produce the cutting kerf 12 in the workpiece 14, a first laser beam 18, a second laser beam 20, and a gas jet 22 are directed at an entrance surface 24 of the workpiece 14. The two laser beams 18, 20 and typically also the gas jet 22 in this case overlap one another in a cutting zone 26. During laser fusion cutting, the material of the workpiece 14 in the cutting zone 26 is liquefied and evacuated by the gas jet 22 while forming the cutting kerf 12.

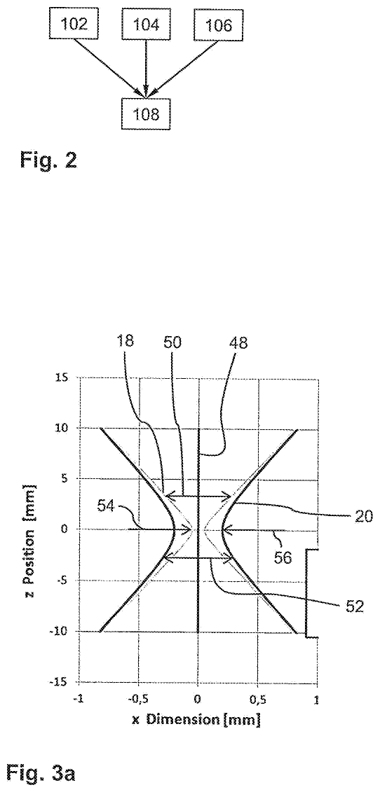

The procedure in principle in the laser cutting method is illustrated in the flowchart of FIG. 2. In a step 102, the first laser beam 18 is produced and directed at the entrance surface 24 of the workpiece 14. In a step 104, the second laser beam 20 is produced and directed at the entrance surface 24 of the workpiece 14. In a step 106, the gas jet 22 is produced and directed at the entrance surface 24 of the workpiece 14. The gas jet 22 and the two laser beams 18, 20 can emerge here from a nozzle 27. The two laser beams 18, 20 and the gas jet 22 overlap one another in the cutting zone 26. In a step 108, the cutting kerf 12 is produced in the workpiece 14 by the two laser beams 18, 20 and the gas jet 22. Steps 102, 104, 106 and step 108 that results from the former steps are in principle carried out at the same time. The distance 70 of the nozzle 27 from the entrance surface 24 of the workpiece 14 can be, for example, 2 mm, but the distance can also be greater or smaller. A dynamic gas pressure of the cutting gas emerging from the nozzle 27 can be 20 bar, for example.

The two laser beams 18, 20 are produced by a laser light source device 28; see FIG. 1a. The laser light source device 28 has in the present case a (single) laser light source 30, for example a solid-state laser. The laser light source 30 emits a (single) output laser beam 32. In a beam splitter 34, the output laser beam 32 is split into the first laser beam 18 and the second laser beam 20. The two laser beams 18, 20 are guided using a multicore fiber 36 to an optical unit 38 of a cutting head (not illustrated in more detail) of the laser cutting apparatus 10.

The multicore fiber 36 has a first fiber core 40 for the first laser beam 18 and a second fiber core 42 for the second laser beam 20; see also FIG. 1b. The second fiber core 42 is embodied in the present case in the form of a ring fiber, which surrounds the first fiber core 40 around its circumference. The first and the second fiber core 40, 42 can be arranged concentrically to each other. A diameter 44 of the first fiber core 40 can be 40 μm. A diameter 46 of the second fiber core 42 can be 150 μm. An intermediate cladding (not shown) having a lower refractive index than the fiber cores 40, 42 can be arranged between the fiber cores 40, 42.

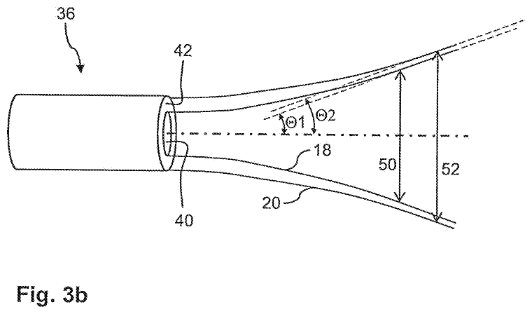

FIGS. 3a and 3b schematically illustrate the path of the two laser beams 18, 20. FIG. 3a shows the beam path in the region of the workpiece 14. The ordinate z here corresponds to the propagation direction of the two laser beams 18, 20. The focus points of the two laser beams 18, 20 here lie, by way of example, at z=0. In principle, the focus points of the two laser beams 18, 20 can be offset with respect to one another in the propagation direction. The abscissa x corresponds to the radius of the laser beams 18, 20 at the respective position along their propagation axis 48. In the present case, the two laser beams 18, 20 run concentric to each other.

A beam diameter 50 of the first laser beam 18 in the region of the workpiece 14 to be cut is smaller than a beam diameter 52 of the second laser beam 20. In particular, a focus diameter 54 of the first laser beam 18 is smaller than a focus diameter 56 of the second laser beam 20. The focus diameter 56 of the second laser beam 20 can be 3.5 times the size of the focus diameter 54 of the first laser beam 18. The beam parameter product of the first laser beam 18 is less than 5 mm*mrad, in the present case for example 2 mm*mrad.

FIG. 3b shows the path and the divergence Θ1, Θ2 of the two laser beams 18, 20 starting from the end of the multicore fiber 36. The divergence Θ1 of the first laser beam 18 and the divergence Θ2 of the second laser beam 20 approach each other asymptotically and are the same size in the far field, just as the beam diameters 50, 52 of the two laser beams 18, 20.

A power proportion of the second laser beam 20 of the total laser power (the sum of the laser powers of the two laser beams 18, 20) is less than 20%. At a thickness 16 of the workpiece 14 of 2 mm, the power proportion of the second laser beam 20 can be, for example, 5%.

The above-described refinement of the laser cutting method causes cutting edges 58 of the cutting kerf 12 to be broken at the entrance surface 24; see FIG. 4a. In other words, the laser cutting method according to the invention achieves that cutting flanks 60 of the cutting kerf 12 and the entrance surface 24 do not adjoin one another at sharp edges but that an ablated area is formed in the region of the cutting edges 58. This improves the inflow conditions for the cutting gas of the gas jet 22 into the cutting kerf 12. As a result, in particular burrs can be prevented from forming on an exit surface 62 of the workpiece 14 that lies opposite the entrance surface 24.

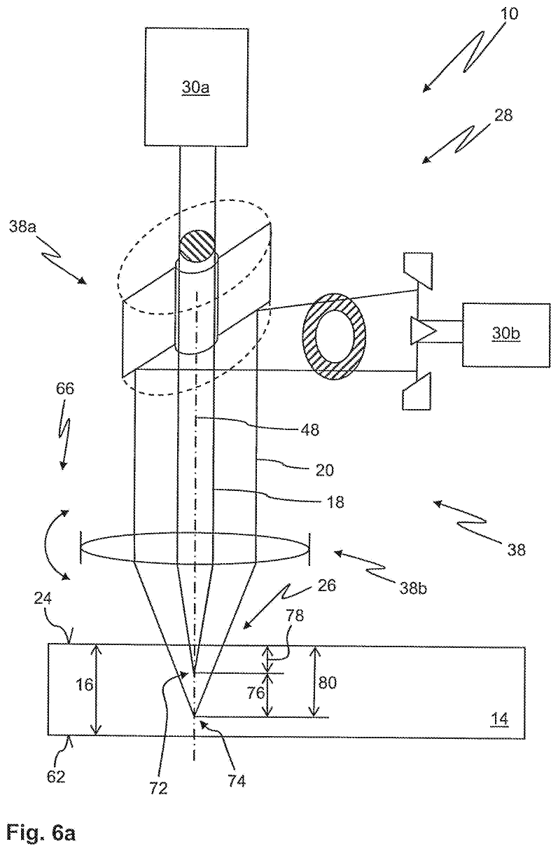

By contrast, cutting edges 58′ of a cutting kerf 12′ have sharp edges at an entrance surface 24′ of a workpiece 14′ in laser cutting methods according to the prior art; see FIG. 5. As a result, less cutting gas passes into the cutting kerf 12′, and the cutting quality or the possible cutting speed remain lower compared to the laser cutting method according to the invention.

FIG. 4b illustrates that the cutting edges 58 in the laser cutting method according to the invention can have a rounded design. For particularly advantageous inflow conditions for the cutting gas of the gas jet 22, a radius 64 of the cutting edges 58 can be 30 μm.

FIG. 4c shows that the ablated area at the cutting edges 58 can also be designed as a bevel. A height or width of the bevels can be at least 20 μm, preferably at least 25 μm, and/or at most 100 μm, preferably at most 60 μm, with very particular preference at most 35 μm. The height and width of the bevels can be, for example, 30 μm.

In order to move the cutting kerf 12 on along an, in particular three-dimensional, cutting line, the cutting zone 26 is moved in relation to the workpiece 14. The laser cutting apparatus 10 can for this purpose have a movement device 66; see FIG. 1a. The movement device 66 can have a workpiece holder 68 that is displaceable in relation to a fixed machine bed. The workpiece 14 is held here on the workpiece holder 68.

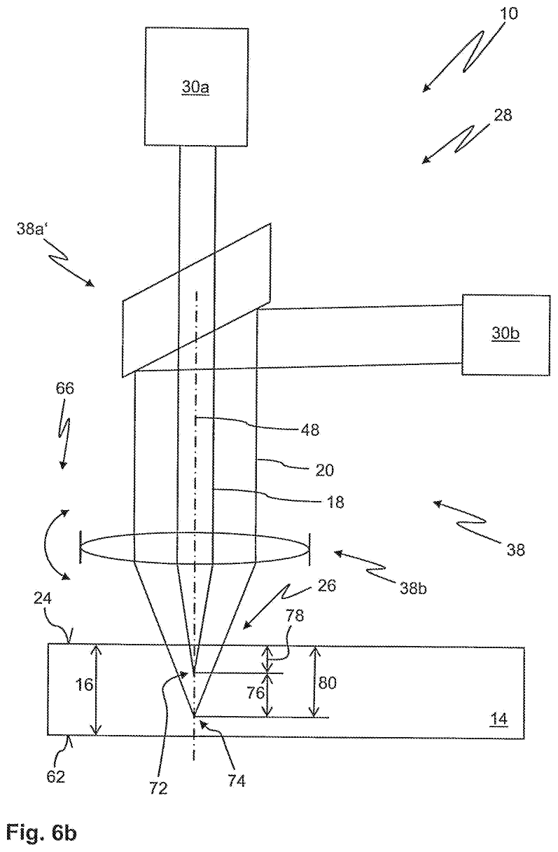

FIGS. 6a and 6b schematically show, by way of example, further variants of the laser cutting apparatus 10 during the performance of a laser cutting method. A laser light source device 28 of the laser cutting apparatus 10 in the present case has two separate laser light sources 30a and 30b to produce the first laser beam 18 and the second laser beam 20. The laser light sources 30a, 30b can be, for example, CO₂ lasers, solid-state lasers or diode lasers. The laser light source device 28 furthermore has an optical unit 38 for overlaying the two laser beams 18, 20 to form an overall laser beam, which optical unit comprises for example a hole mirror 38a (FIG. 6a) or a wavelength-selective beam splitter mirror 38a′ (FIG. 6b) and a focusing lens element 38b. The laser beams 18, 20 can be overlaid concentrically to each other, with the result that they propagate along a common propagation axis 48 toward the workpiece 14.

A focus point 72 of the first laser beam 18 can be offset along the propagation axis 48 with respect to a focus point 74 of the second laser beam 20. The focus point 72 of the first laser beam 18 lies here upstream of the focus point 74 of the second laser beam 20 in the propagation direction of the laser beams 18, 20. A distance 76 between the focus points 72, 74 along the propagation axis 48 can be, for example, 0.7 mm.

The second focus point 74 and preferably also the first focus point 72 can lie inside the workpiece 14, that is to say beyond the entrance surface 24 in the propagation direction of the laser beams 18, 20. A distance 78 of the first focus point 72 from the entrance surface 24 can be, for example, a quarter of the thickness 16 of the workpiece 14. A distance 80 of the second focus point 74 from the entrance surface 24 can be less than twice, for example 1.5 times, the Rayleigh length of the second laser beam 20.

The further parameters of the laser cutting apparatus 10 of FIG. 6 or of the laser cutting method described in this connection can be chosen as in the previously described laser cutting method and the laser cutting apparatus 10 of FIG. 1a. Accordingly, the arrangement of the focus points 72, 74 of the two laser beams 18, 20 in relation to one another and in relation to the workpiece 14 described here can also be provided in the previously described laser cutting method and the laser cutting apparatus 10 of FIG. 1a.

A movement unit 66 of the laser cutting apparatus 10 of FIG. 6 can be configured to tilt the optical unit 38 or parts of the optical unit 38 with respect to the workpiece 14. In addition, the optical unit 38 and the workpiece 14 can be moved translationally relative to each other. In this way, a cutting zone 26 can be moved along an, in particular three-dimensionally extending, cutting line to form a cutting kerf. Due to the tilting, an at least approximately rectangular incidence of the laser beams 18, 20 and of the gas jet 22 on the workpiece 14 can be arranged, in particular if the workpiece 14 has a three-dimensionally shaped entrance surface 24. In the laser cutting apparatus 10 of FIG. 1a, the optical unit 38 or parts of the optical unit 38 can also be tiltable with respect to the workpiece 14.

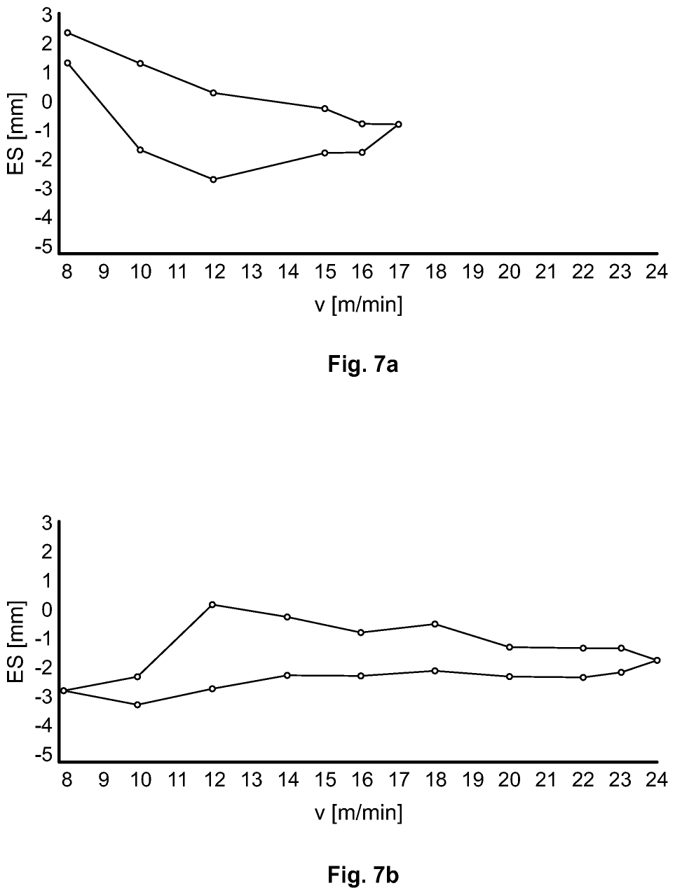

FIGS. 7a and 7b show diagrams of cutting speeds that are ascertained experimentally in laser cutting methods according to the invention and at which a good quality of the cutting kerf 12, in particular of the cutting flanks 60 and the cutting edges 58, is also attained as a function of the focus location (denoted here by “ES”) of the first laser beam relative to the exit opening of the nozzle 27 (see FIG. 4a). In the diagram of FIG. 7a, the power proportion of the second laser beam 20 of the total laser power is 10%; in the diagram of FIG. 7b, the power proportion of the second laser beam 20 of the total laser power is 5%.

FIGS. 7a and 7b show diagrams for cutting workpieces with a workpiece thickness 16 of 2 mm at a total laser power of 3 kW. The plotted points each show the largest possible cutting speed at which a good cutting quality was still obtained. In other words, a good cutting quality was obtained for parameter pairs within the plotted lines. It can be seen that at a power proportion of the second laser beam 20 of 5% significantly higher cutting speeds can be attained than at a power proportion of 10%. Nevertheless, the power proportion of the second laser beam 20 must not vanish but must ensure the improvement of the flow of the cutting gas into the cutting kerf 12 via the formation of the broken cutting edges 58 and consequently in particular have the effect that no burrs form on the exit surface 62 of the workpiece 14.

Experiments have further shown that workpieces having a thickness 16 of less than 6 mm with a small focus diameter 54 of 100 μm of the first laser beam 18 can be cut more than 30% faster than with a focus diameter 54 of 150 μm, specifically at up to 24 m/min

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Laser cutting apparatus 10
Cutting kerf 12
Workpiece 14
Thickness 16 of the workpiece
First laser beam 18
Second laser beam 20
Gas jet 22
Entrance surface 24
Cutting zone 26
Nozzle 27
Laser light source device 28
Laser light source 30
Output laser beam 32
Beam splitter 34
Multicore fiber 36
Optical unit 38
Hole mirror 38a
Beam splitter mirror 38a′
Focusing lens element 38b
First fiber core 40
Second fiber core 42
Diameter 44 of the first fiber core 40
Diameter 46 of the second fiber core 42
Propagation axis 48
Beam diameter 50 of the first laser beam 18
Beam diameter 52 of the second laser beam 20
Focus diameter 54 of the first laser beam 18
Focus diameter 56 of the second laser beam 20
Cutting edges 58
Cutting flanks 60
Exit surface 62
Radius 64 of the cutting edges 58
Movement device 66
Workpiece holder 68
Distance 70 between the nozzle 27 and the entrance surface 24
Focus point 72 of the first laser beam 18
Focus point 74 of the second laser beam 20
Distance 76 between the focus points 72, 74
Distance 78 of the first focus point 72 from the entrance surface 24
Distance 80 of the second focus point 74 from the entrance surface 24
Divergence Θ1, Θ2
Step 102: Directing the first laser beam 18 at the entrance surface 24
Step 104: Directing the second laser beam 20 at the entrance surface 24
Step 106: Directing the gas jet 22 at the entrance surface 24
Step 108: Producing the cutting kerf 12 in the workpiece 14

1. A method for laser cutting a workpiece having a thickness of less than 6 mm, the method comprising:
directing a first laser beam, a second laser beam, and a gas jet at an entrance surface of the workpiece such that the first and second laser beams at least partially overlap one another on the workpiece,
wherein the first laser beam has a smaller focus diameter than the second laser beam,
wherein a beam parameter product of the first laser beam is at most 5 mm*mrad,
wherein a power proportion of the second laser beam of a total laser power is less than 20%, and
wherein a cutting kerf with a broken cutting edge is formed on the entrance surface of the workpiece.

2. The method as claimed in claim 1, wherein the beam parameter product of the first laser beam is at most 3 mm*mrad.

3. The method as claimed in claim 1, wherein a radius of the cutting edge is at least 20 μm and/or at most 100 μm.

4. The method as claimed claim 1, wherein the thickness of the workpiece is less than 5 mm, and wherein the power proportion of the second laser beam of the total laser power is less than 15%.

5. The method as claimed in claim 1, wherein the thickness of the workpiece is less than 3 mm and wherein the power proportion of the second laser beam of the total laser power is less than 7%.

6. The method as claimed in claim 1, wherein a focus point of the first laser beam lies upstream of a focus point of the second laser beam in a propagation direction.

7. The method as claimed in claim 1, wherein a distance between focus points of the two laser beams is not more than 2 mm.

8. The method as claimed in claim 1, wherein a distance of a focus point of the second laser beam from the entrance surface of the workpiece is at most twice a Rayleigh length of the second laser beam.

9. The method as claimed in claim 1, wherein a focus diameter of the second laser beam is at least twice and/or at most five times a focus diameter of the first laser beam.

10. The method as claimed in claim 1, wherein a far field divergence of the first laser beam and a far field divergence of the second laser beam differ by at most 100 mrad.

11. The method as claimed in claim 1, wherein the two laser beams are overlaid concentrically with respect to one another.

12. The method as claimed in claim 1, wherein the two laser beams emerge from a multicore fiber having a first fiber core for the first laser beam and a second fiber core for the second laser beam.

13. The method as claimed in claim 12, wherein the first fiber core has a diameter of at most 100 μm.

14. The method as claimed in claim 1, wherein a gas pressure of the gas jet is at least 16 bar.

15. The method as claimed in claim 1, wherein the laser cutting apparatus is a laser fusion cutting apparatus.

16. The method as claimed in claim 1, wherein the workpiece is at least one of metallic and electrically conductive.

17. A laser cutting apparatus for laser cutting a workpiece along a cutting line, the apparatus comprising:
a laser light source device for overlaying a first laser beam and a second laser beam in a cutting zone, wherein the first laser beam has a smaller focus diameter than the second laser beam, wherein a beam parameter product of the first laser beam is at most 5 mm*mrad, and wherein a power proportion of the second laser beam of a total laser power is less than 20%;
a nozzle for directing a gas jet at the cutting zone; and
a movement device for moving the cutting zone relative to the workpiece along the cutting line.
